(19) United States
(12) Patent Application Publication
(10) Pub. No.: US 2026/0257368 A1
(43) Pub. Date: Sep. 3, 2026

(54) ROBOT ARM CALIBRATION

(71) Applicant: KUKA Deutschland GmbH, Augsburg (DE)

(72) Inventor: Daniel Knott, Friedberg (DE)

(73) Assignee: KUKA Deutschland GmbH, Augsburg (DE)

(21) Appl. No.: 18/876,068

(22) PCT Filed: Sep. 7, 2023
(86) PCT No.: PCT/EP2023/074534

§ 371 Date: Dec. 17, 2024

(30) Foreign Application Priority Data
Sep. 28, 2022 (DE) 10 2022 210 253.3

(51) Int. Cl. B25J 9/16

(52) U.S. Cl. CPC B25J 9/1692; B25J 9/1664

(57) ABSTRACT

A method for calibrating a robot arm with the aid of a measuring device that has a first calibration element and a calibration element which is fixed to the robot arm and which can be moved relative to the first calibration element by adjusting joints of the robot arm. The first calibration element and the calibration element fixed to the robot arm are designed such that, in the event of a displacement of the calibration element fixed to the robot arm relative to the first calibration element in an advance direction, the calibration element fixed to the robot arm is guided by the first calibration element from various starting positions to the same defined end position. The method includes positioning the calibration element fixed to the robot arm relative to the first calibration element in one of the starting positions, and moving in a force-controlled manner the calibration element fixed to the robot arm relative to the first calibration element in the advance direction with the aid of the robot arm. During this movement, the calibration element fixed to the robot arm is guided by the first calibration element to the end position, and at this position the robot has a calibration setting, Joint settings of the robot arm in the calibration setting are detected, the robot arm is calibrated on the basis of the joint settings.

### CROSS-REFERENCE TO RELATED APPLICATIONS

This application is a national phase application under 35 U.S.C. § 371 of International Patent Application No. PCT/EP2023/074534, filed Sep. 7, 2023 (pending), which claims the benefit of priority to German Patent Application No. DE 10 2022 210 253.3, filed Sep. 28, 2022, the disclosures of which are incorporated by reference herein in their entirety.

### TECHNICAL FIELD

The present invention relates to a method for calibrating a robot arm, as well as to a system, a computer program or a computer program product for carrying out a method described herein.

### SUMMARY

The object of the present invention is to improve calibration of a robot arm.

This object is achieved by a method, a system, and a computer program or computer program product for carrying out a method as described herein.

According to one embodiment in accordance with the present invention, a robot arm comprises multiple, preferably at least three, in particular at least six, in one embodiment at least seven, joints or (movement) axes, in one embodiment rotary joints.

According to one embodiment in accordance with the present invention, a measuring device comprises at least two calibration elements, each of which can be formed in one or more parts.

In one embodiment, one of the calibration elements is a calibration element fixed to the robot arm and, in a further development, is arranged on the robot arm, preferably on its (distal) end flange or tool flange or link, in a stationary manner, in one embodiment (non-destructively) detachably, in another embodiment (not non-destructively, i.e.) non-detachably, or permanently.

The, or another of the, calibration element(s) is referred to in one embodiment without loss of generality as the first calibration element. In one embodiment, this element is stationary relative to a rigid or mobile surroundings and/or base of the robot arm; in one embodiment it is arranged on the surroundings or robot arm base (non-destructively) detachably, in another embodiment (not non-destructively, i.e.) non-detachably, or permanently.

The calibration element fixed to the robot arm can be moved relative to the first calibration element by adjusting the joints of the robot arm, wherein the first calibration element and the calibration element fixed to the robot arms are designed such that when the calibration element fixed to the robot arm is displaced relative to the first calibration element in a spatial direction, which is referred to here without restriction of generality as the first advance direction, the calibration element fixed to the robot arm is (forcibly) guided from different starting positions, which are referred to here without restriction of generality as the first starting positions, by the first calibration element, preferably mechanically or in a positive-fitting manner, (ultimately) in each case into the same, in particular clearly defined, preferably singular or unambiguous, end position, which is referred to here without restriction of generality as the first end position. A simple and at the same time preferred example is a funnel for guiding a ball: if the ball is moved into the funnel relative to the funnel, it comes into contact with the funnel surface. During a subsequent further movement into the funnel, the funnel guides the ball inwards to a defined end position. This can preferably be achieved by a ball that is fixed to the robot arm or is guided, but of course also by moving the funnel fixed to the robot arm relative to the ball fixed to the surroundings.

According to one embodiment in accordance with the present invention, the method for calibrating the robot arm with the aid of the measuring device comprises the steps:
positioning the calibration element fixed to the robot arm relative to the first calibration element in one of the starting positions with the aid of the robot arm;
force-controlled movement, preferably with the aid of an impedance control of the robot arm, of the calibration element fixed to the robot arm relative to the first calibration element in the first advance direction with the aid of the robot arm, wherein during this (force-controlled) movement the calibration element fixed to the robot arm is (forcedly) guided into the first end position by the first calibration element, preferably mechanically or positively, and the robot comprises a calibration setting at this first end position, which is referred to here without restriction of generality as the first calibration setting;
detecting settings of the joints of the robot arm in the first calibration setting, in one embodiment with the aid of sensors on the joints, which are referred to here without loss of generality as first settings; and
calibrating the robot arm on the basis of these first joint settings, in particular on the basis of the first joint settings and the known, preferably predetermined and/or measured, first end position, wherein in one embodiment the first end position is known, preferably predetermined and/or measured, relative to the robot arm, in particular its base, and/or relative to a surroundings of the robot arm, in particular a base of the measuring device.

By means of the force-controlled, in one embodiment impedance-controlled, movement of the calibration element fixed to the robot arm with the aid of the robot arm in conjunction with the (forced) guidance by the first calibration element, in one embodiment the calibration element fixed to the robot arm can advantageously be arranged reliably, precisely, quickly and/or in different guide directions, for example also horizontally or vertically upwards or the like, in the first end position, and this can be used to calibrate the robot arm.

In one embodiment, the measuring device comprises at least one further calibration element, which is referred to without restriction of generality as a second calibration element and in one embodiment is also arranged in a stationary manner relative to the surroundings and/or base of the robot arm, in one embodiment is arranged on the surroundings or robot arm base (non-destructively) detachably, in another embodiment (not non-destructively, i.e.) non-detachably, or permanently.

The calibration element fixed to the robot arm can also be moved relative to the second calibration element by adjusting the joints of the robot arm, in particular after it has been initially arranged in the second end position and then moved out of this position, wherein the second calibration element and the calibration element fixed to the robot arm are designed such that when the calibration element fixed to the robot arm is displaced relative to the second calibration element in a spatial direction, which is referred to here without restriction of generality as the second advance direction, the calibration element fixed to the robot arm is (forcibly) guided from different starting positions, which are referred to here without restriction of generality as second starting positions, by the second calibration element, preferably mechanically or in a positive-fitting manner, in each case into the same defined end position, which is referred to here without restriction of generality as the second end position.

In a further development of this embodiment, the method with respect to the second calibration element comprises the same steps as described above with respect to the first calibration element, or the steps:
positioning the calibration element fixed to the robot arm relative to the second calibration element with the aid of the robot arm in one of the second starting positions, preferably after it has first been moved with the aid of the robot arm to the first end position, in which the first settings and optionally the further settings of the joints of the robot arm have been detected and then the calibration element fixed to the robot arm has been moved away from the first end position again, in particular out of the first calibration element;
force-controlled movement of the calibration element fixed to the robot arm relative to the second calibration element in the second advance direction with the aid of the robot arm, wherein during this (force-controlled) movement the calibration element fixed to the robot arm is (forcedly) guided by the second calibration element, preferably mechanically or positively, into the second end position and in this end position the robot comprises a calibration setting, which is referred to here without restriction of generality as the second calibration setting; and
detecting settings of the joints of the robot arm in the second calibration setting, which are referred to herein without loss of generality as second settings;
wherein the robot arm is calibrated on the basis of the first and also these second joint settings, preferably also on the basis of the known, in one embodiment predetermined and/or measured, second end position, wherein in one embodiment the second end position is known, preferably predetermined and/or measured relative to the robot arm, in particular its base, and/or relative to a surroundings of the robot arm, in particular a base of the measuring device.

In a further development, the measuring device comprises at least one further calibration element, which is referred to without restriction of generality as a further second or third calibration element and in one embodiment is also arranged on the surroundings or robot arm base in a stationary manner relative to the surroundings and/or base of the robot arm, in one embodiment (non-destructively) detachably, in another embodiment (not non-destructively, i.e.) non-detachably, or permanently.

The calibration element fixed to the robot arm can also be moved relative to the third or further second calibration element by adjusting the joints of the robot arm, in particular after it has been initially arranged in the first end position, then moved away from this position and arranged in the (a) second end position and then moved away from this position, wherein this third or further second calibration element and the calibration element fixed to the robot arm are designed in such a way that when the calibration element fixed to the robot arm is displaced relative to the third or further second calibration element in a spatial direction, which is referred to here without restriction of generality as the third or further second advance direction, the calibration element fixed to the robot arm is (forcibly) guided from different starting positions, which are referred to here without restriction of generality as the third or further second starting positions, by the third or further second calibration element, preferably mechanically or positively, in each case into the same defined end position, which is referred to here without restriction of generality as the third or further second end position.

In a further development of this embodiment, the method comprises the same steps as described above with reference to the first and (a) second calibration element, or the steps:
positioning the calibration element fixed to the robot arm relative to the third or further second calibration element with the aid of the robot arm in one of the third or further second start positions preferably after it has first been moved into the first end position with the aid of the robot arm, in which the first settings and possibly the further settings of the joints of the robot arm have been detected and then the robot arm-fixed calibration element has been moved away from the first end position again, in particular out of the first calibration element, and then moved into the (a) second end position with the aid of the robot arm, in which the (a) second settings and possibly further settings of the joints of the robot arm have been detected and then the calibration element fixed to the robot arm has been moved away again from the (a) second end position, in particular out of the (a) second calibration element;
force-controlled movement of the calibration element fixed to the robot arm relative to the third or further second calibration element in the third or further second advance direction with the aid of the robot arm, wherein during this (force-controlled) movement the calibration element fixed to the robot arm is (forcibly) guided by the third or further second calibration element, preferably mechanically or positively, into the third or further second end position and the robot comprises a calibration setting in this end position, which is referred to here without restriction of generality as the third or further second calibration setting; and
detecting settings of the joints of the robot arm in the third or further second calibration setting, which are referred to here without restriction of generality as third or further second settings;
wherein the robot arm is calibrated on the basis of the first, the (a) second and also this third or further second joint settings, preferably also on the basis of the known, in one embodiment predetermined and/or measured, third or further second end position, wherein in one embodiment this third or further second end position is known, preferably predetermined and/or measured relative to the robot arm, in particular its base, and/or relative to a surroundings of the robot arm, in particular a base of the measuring device.

By means of one or more second calibration elements, which are preferably (arranged) spaced apart from one another and/or the first calibration element, in one embodiment the calibration, in particular its precision, can be improved and/or more dimensions or parameters can be determined.

In one embodiment, the method comprises the steps of:
adjusting the robot arm from the first calibration setting into at least one further calibration setting in which the calibration element fixed to the robot arm is (also) arranged in the first end position, wherein the calibration element fixed to the robot arm preferably remains arranged in the first end position during this adjustment with the aid of the force-controlled robot arm or is guided back into the first end position by the first calibration element during force-controlled movement of the calibration element fixed to the robot arm relative to the first calibration element in the first advance direction; and
detecting further settings of the joints of the robot arm in this further calibration setting;
wherein the robot arm is calibrated based on the first and these further joint settings.

Additionally or alternatively, in one embodiment the method comprises the steps of:
adjusting the robot arm from the or at least one of the second calibration setting(s) into at least one further calibration setting in which the calibration element fixed to the robot arm is arranged in the second end position in which it was arranged in this second calibration setting, wherein the calibration element fixed to the robot arm preferably remains arranged in this second end position during this adjustment with the aid of the robot arm force-controlled for this purpose, or is guided back into the (corresponding) second end position by the corresponding second calibration element during force-controlled movement of the calibration element fixed to the robot arm relative to this second calibration element in the (corresponding) second advance direction; and
detecting further settings of the joints of the robot arm in this further calibration setting;
wherein the robot arm is also calibrated based on these additional joint settings.

In this way, in one embodiment, different calibration or joint settings of the robot arm can be detected in the same or for the same end position and used for calibration, thereby improving in particular the calibration, in particular its precision, and/or a time and/or space requirement and/or determining more dimensions or parameters.

In one embodiment, when adjusting the robot arm from the first calibration setting to a further calibration setting in which the calibration element fixed to the robot arm is arranged in the first end position, when adjusting the robot arm between at least two calibration settings A, B of the robot arm, one of which can be the first calibration setting, or both calibration settings can be different from the first calibration setting, the calibration element fixed to the robot arm is arranged in the first end position and an orientation of the calibration element fixed to the robot arm relative to the first calibration element is maintained (during this adjustment of the robot arm between the two calibration settings A, B of the robot arm), during the detection settings of the joints of the robot arm are detected in these at least two calibration settings A, B, and the robot arm is (also) calibrated on the basis of these detected settings of the joints.

Additionally or alternatively, in one embodiment, when adjusting the robot arm from the or at least one of the second calibration setting(s) to the or at least one of the further calibration setting(s), in which the calibration element fixed to the robot arm is arranged in the (corresponding) second end position in which it was arranged in this (corresponding) second calibration setting, when adjusting the robot arm between at least two calibration settings A′, B′ of the robot arm, one of which can be the (corresponding) second calibration setting or both calibration settings can be different from the (corresponding) second calibration setting, the calibration element fixed to the robot arm is arranged in the (corresponding) second end position and an orientation of the calibration element fixed to the robot arm relative to the (corresponding) second calibration element is maintained (during this adjustment of the robot arm between the two calibration settings A′, B′ of the robot arm), during the detection settings of the joints of the robot arm in these at least two calibration settings A′, B′ are detected, and the robot arm is (also) calibrated based on these detected settings of the joints.

Thus, in one embodiment, the robot arm (in each case) is adjusted in such a way that it not only maintains the position but also the orientation of the calibration element fixed to the robot arm relative to the corresponding calibration element, or adjusts it in its corresponding zero space.

As a result, in one embodiment additional joint settings can be approached particularly advantageously for calibration, preferably with a low(er) load on the calibration elements. Additionally or alternatively, in one embodiment, additional joint settings can be used for calibration by adjusting the robot arm in its corresponding zero space.

In addition or alternatively, in an embodiment when adjusting the robot arm from the first calibration setting to a further calibration setting in which the calibration element fixed to the robot arm is arranged in the first end position, in at least two calibration settings U, V of the robot arm, one of which can be the first calibration setting, or both calibration settings can be different from the first calibration setting, the calibration element fixed to the robot arm is arranged in the first end position and the calibration element fixed to the robot arm comprises different orientations relative to the first calibration element in these at least two calibration settings U, V relative to the first calibration element or, during this adjustment of the robot arm between the two calibration settings U, V of the robot arm, the calibration element fixed to the robot arm changes its orientation relative to the first calibration element, during the detection settings of the joints of the robot arm are detected in these at least two calibration settings U, V, and the robot arm is (also) calibrated on the basis of these detected settings of the joints.

Additionally or alternatively, in one embodiment, when adjusting the robot arm from the or at least one of the second calibration setting(s) to the or at least one of the further calibration setting(s), in which the calibration element fixed to the robot arm is arranged in the (corresponding) second end position in which it was arranged in this (corresponding) second calibration setting, in at least two calibration settings U′, V′ of the robot arm, one of which can be the (corresponding) second calibration setting or both calibration settings can be different from the (corresponding) second calibration setting, the calibration element fixed to the robot arm is arranged in the (corresponding) second end position and the calibration element fixed to the robot arm comprises, relative to the (corresponding) second calibration element in these at least two calibration settings U′, V′, different orientations relative to the (corresponding) second calibration element, or during this adjustment of the robot arm between the two calibration settings U′, V′ of the robot arm the calibration element fixed to the robot arm changes its orientation relative to the (corresponding) second calibration element, during the detection settings of the joints of the robot arm in these at least two calibration settings U′, V′ are detected, and the robot arm is (also) calibrated based on these detected settings of the joints.

Thus, in one embodiment, only the position of the calibration element fixed to the robot arm relative to the corresponding calibration element is maintained, but its orientation relative to the corresponding calibration element is changed.

As a result, in one embodiment, additional joint settings can advantageously be approached more easily and/or more precisely for calibration and/or additional joint settings can be used for calibration, in particular if the robot arm does not have a corresponding zero space in the corresponding starting (calibration) position.

The two variants mentioned above can be particularly advantageously combined with one another, in particular sequentially, in particular by adjusting the robot arm between two calibration settings in which the calibration element fixed to the robot arm comprises different orientations, but the same position, relative to the corresponding calibration element, the robot arm is then adjusted while maintaining the position and orientation, and/or after adjusting the robot arm between two calibration settings in which the calibration element fixed to the robot arm comprises the same position and orientation relative to the corresponding calibration element, the robot arm is then adjusted while maintaining the position and changing the orientation.

This makes it particularly advantageous to use additional joint settings for calibration and thus improves the calibration, in particular its precision and/or speed. It can be particularly advantageous to approach more than two calibration settings while maintaining the position and orientation of the calibration element fixed to the robot arm relative to the corresponding calibration element and to use the joint settings recorded in these calibration settings for the calibration.

In one embodiment, in the first calibration setting, in a further development when adjusting from the first calibration setting into the further calibration setting and/or at least during the detection of the joint settings in the first and/or this further calibration setting, the robot arm is force-controlled in such a way that the calibration element fixed to the robot arm in the first end position exerts a contact force on the first calibration element and is supported by the first calibration element in the first end position.

Additionally or alternatively, in the or at least one of the second calibration settings, in a further development when adjusting from the or at least one of the second calibration settings to the corresponding further calibration setting and/or at least during the detection of the joint settings in the (corresponding) second and/or this further calibration setting, the robot arm is force-controlled in such a way that the calibration element fixed to the robot arm exerts a contact force on the corresponding second calibration element in the (corresponding) second end position and is supported by the corresponding second calibration element in the (corresponding) second end position.

In one embodiment, the calibration element fixed to the robot arm can thereby advantageously be secured in its corresponding end position and, as a result, the calibration, in particular its precision, and/or the time required can be improved.

In one embodiment, the first calibration element comprises a guide surface with a cavity, wherein the calibration element fixed to the robot arm can be supported by the cavity in a defined support position which determines the first end position, wherein the guide surface converges towards the cavity, preferably in a funnel-like manner.

In a further development, the or one or more of the second calibration element(s) each comprise a guide surface with a cavity, wherein the calibration element fixed to the robot arm can be supported by the (corresponding) cavity in a defined support position which determines the (corresponding) second end position, wherein the guide surface converges towards the cavity, preferably in a funnel-like manner. Additionally or alternatively, the calibration element fixed to the robot arm comprises an at least partially spherical or (partially) spherical contact or surface for sliding on the (corresponding) guide surface. Additionally or alternatively, in one embodiment the or one or more of the guide surface(s) each have one or more guides which are designed to guide the calibration element fixed to the robot arm into the (corresponding) cavity along (in each case) a one-dimensional, preferably at least partially straight, guide path.

In another embodiment, conversely, the calibration element fixed to the robot arm comprises a guide surface with a cavity, wherein the first calibration element can be supported by the cavity in a defined support position which determines the first end position, wherein the guide surface converges towards the cavity, preferably in a funnel-like manner.

In a further development, the first calibration element and, in one embodiment, also the or one or more of the second calibration element(s) each have an at least partially spherical or (partially) spherical contact or surface for sliding on this guide surface. Additionally or alternatively, in one embodiment the guide surface comprises one or more guides which are designed to guide the first or (corresponding) second calibration element fixed to the robot arm into the (corresponding) cavity along (in each case) a one-dimensional, preferably at least partially straight, guide path.

In this way, in an embodiment the mechanical or positive guidance or calibration, in particular its precision, and/or time and/or space requirements can be improved.

In one embodiment, the method comprises the step of:
force-controlled movement of the calibration element fixed to the robot arm relative to the first calibration element with the aid of the robot arm, wherein during this movement the calibration element fixed to the robot arm is guided by the guide along the guide path and settings of the joints of the robot arm are detected in at least two calibration settings;
wherein the robot arm is calibrated based on these joint settings.

In a further development, the method comprises the step of:
force-controlled movement of the calibration element fixed to the robot arm relative to the, or to one or more of the, second calibration element(s) in each case with the aid of the robot arm, wherein during this movement the calibration element fixed to the robot arm is guided by the (corresponding) guide along the guide path and settings of the joints of the robot arm are detected in at least two calibration settings;
wherein the robot arm is calibrated based on these joint settings.

In one embodiment, the one or more guides (each) comprise at least one edge, preferably a groove, in the guide surface.

In one embodiment, the (corresponding) guide provides a defined direction which can be detected by the at least two calibration settings and thus advantageously used for calibration. In one embodiment, this can improve calibration, in particular its precision, and/or a time and/or space requirement.

According to one embodiment in accordance with the present invention, a system, in particular in terms of hardware and/or software, in one embodiment in terms of programming, is configured to carry out a method described herein.

According to one embodiment in accordance with the present invention, a, or the, system comprises a measuring device as described herein, and can in particular consist thereof.

Additionally or alternatively, according to an embodiment in accordance with the present invention, a, or the, system comprises a controller which, in particular in terms of hardware and/or software, in one embodiment in terms of programming, is configured for and in particular can consist of:
controlling the robot arm to position the calibration element fixed to the robot arm relative to the first calibration element in one of the first starting positions with the aid of the robot arm;
controlling the robot arm to move, in a force-controlled manner, the calibration element fixed to the robot arm relative to the first calibration element in the first advance direction with the aid of the robot arm, wherein during this movement the calibration element fixed to the robot arm is guided by the first calibration element to the first end position and at this end position the robot comprises a first calibration setting; and
detecting first settings of the joints of the robot arm in the first calibration setting; preferably with the aid of corresponding sensors.

Additionally or alternatively, according to an embodiment in accordance with the present invention, a, or the, system, in particular its controller, comprises a calibration means for calibrating the robot arm on the basis of the detected first joint settings, and can in particular consist of this.

In one embodiment, in particular in terms of hardware and/or software, in one embodiment in terms of programming, the controller is configured for
controlling the robot arm to position the calibration element fixed to the robot arm relative to the second calibration element in one of the second starting positions with the aid of the robot arm;
controlling the robot arm to move, in a force-controlled manner, the calibration element fixed to the robot arm relative to the second calibration element in the second advance direction with the aid of the robot arm, wherein during this movement the calibration element fixed to the robot arm is guided by the second calibration element to the second end position and at this end position the robot comprises a second calibration setting; and
detecting second settings of the joints of the robot arm in the second calibration setting, preferably with the aid of corresponding sensors;
and/or the calibration means is configured for calibrating the robot arm based on the first and second joint settings.

In one embodiment, in particular in terms of hardware and/or software, in one embodiment in terms of programming, the controller is configured for
controlling the robot arm to adjust the robot arm from the first calibration setting into at least one further calibration setting in which the calibration element fixed to the robot arm is arranged in the first end position; and
detecting further settings of the joints of the robot arm in this further calibration setting;
and/or the calibration means is configured for calibrating the robot arm based on these further joint settings as well.

In one embodiment, in particular in terms of hardware and/or software, in one embodiment in terms of programming, the controller is set up so that
when adjusting the robot arm from the first calibration setting to a further calibration setting in which the calibration element fixed to the robot arm is arranged in the first end position, when adjusting the robot arm between at least two calibration settings of the robot arm, the calibration element fixed to the robot arm is arranged in the first end position and an orientation of the calibration element fixed to the robot arm relative to the first calibration element is maintained, and during the detection settings of the joints of the robot arm in these at least two calibration settings are detected; and/or
when adjusting the robot arm from the first calibration setting into a further calibration setting in which the calibration element fixed to the robot arm is arranged in the first end position, in at least two calibration settings of the robot arm the calibration element fixed to the robot arm is arranged in the first end position and the calibration element fixed to the robot arm comprises different orientations relative to the first calibration element in these at least two calibration settings, and during the detection settings of the joints of the robot arm are detected in these at least two calibration settings,
and/or the calibration means is configured for calibrating the robot arm based on these detected joint settings as well.

In one embodiment, in particular in terms of hardware and/or software, in one embodiment in terms of programming, the controller is configured for
controlling the robot arm for the force-controlled movement of the calibration element fixed to the robot arm relative to the first calibration element with the aid of the robot arm, wherein during this movement the calibration element fixed to the robot arm is guided by the guide along the guide path and settings of the joints of the robot arm are detected in at least two calibration settings, preferably with the aid of corresponding sensors;
and/or the calibration means is configured for calibrating the robot arm of these joint settings.

A system and/or a means in the sense of the present invention may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be designed in such a way that it embodies or is capable of carrying out the methods described herein, so that the processing unit is able to carry out the steps of such methods and therefore, in particular, is able to control and/or calibrate the robot arm. Controlling in the sense of the present invention is understood in particular to mean regulating or commanding based on a deviation between target and actual values. In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of multiple computers, causes the system or controller, in particular the computer(s), to carry out a method described herein or one or more steps thereof, or the program or instructions are configured to do so.

In one embodiment, one or more, in particular all, steps of the method are fully or partially computer-implemented or one or more, in particular all, steps of the method are carried out in fully or partially automated fashion, in particular by the system or its means.

In an embodiment, the system comprises the robot arm.

Calibrating a robot arm can in particular comprise determining parameters of a, preferably kinematic, model of the robot arm.

In one embodiment, such a model maps settings q of the joints of the robot arm and poses X of a robot-fixed reference, preferably an end flange, end effector, TCP or the like, to each other and is a function of parameters p, wherein a pose can describe a one-, two- or three-dimensional position and/or a one-, two- or three-dimensional orientation in the usual manner (forward kinematics: X=V(q, p) or backward kinematics q=V(X, p′)). Through corresponding value pairs {Xᵢ, qᵢ} the parameters can be determined in a known manner, for example with the aid of minimizing the measurement errors Σ|Xᵢ−V(qᵢ,p)| or the like.

Calibrating a robot arm can in particular include determining transformations between coordinate systems fixed to the robot arm and coordinate systems fixed to the surroundings.

In one embodiment, a pose of the calibration element fixed to the robot arm can be described on the one hand by a transformation from a coordinate system fixed to the surroundings into a coordinate system fixed to the robot arm base, from there—in particular by means of a, preferably kinematic, model of the robot arm depending on its joint settings—into an end flange-fixed coordinate system and the pose of the calibration element fixed to the robot arm described therein and on the other hand in the coordinate system fixed to the surroundings and the pose of the calibration element fixed to the robot arm described therein in the respective end position. Accordingly, through corresponding value pairs {Xᵢ, qᵢ}, in a manner known per se, the transformation can be determined between a coordinate system fixed to the surroundings and a coordinate system fixed to the robot arm base (and thus, in one embodiment, the pose of the robot arm or its base relative to the coordinate system fixed to the surroundings) and/or the transformation between a coordinate system fixed to the end flange and a coordinate system fixed to the end effector or to the calibration element.

In general, in one embodiment the calibration of the robot arm is carried out on the basis of the detected (first, further, and/or second) joint settings and the known end position(s) specified and/or measured in an embodiment.

In one embodiment, a detection comprises a preferably sensor-based detection and/or storing of measured values.

In one embodiment, the calibration element fixed to the robot arm exerts, as a result of the force-controlled movement when moving to the first end position, a contact force, in a further development a predetermined or target contact force, on the first calibration element, and/or when moving to the second end position exerts a contact force, in a further development a predetermined or target contact force, on the second calibration element. In one embodiment, this makes it possible to improve the approach to the end position and thus the calibration, in particular its precision, and/or a time requirement. Additionally or alternatively, the corresponding advance direction can advantageously deviate from a direction of gravity; for example, the robot arm can also move the calibration element fixed to the robot arm horizontally, overhead or the like, into the corresponding end position.

In one embodiment, a force-controlled movement can also include additional position controlling, in particular a hybrid force-position controlling. In particular, a force-controlled movement in a advance direction can comprise a position-controlled movement in the advance direction and a force-controlled movement, in particular evasion, transversely thereto.

In one embodiment, a force-controlled movement in an advance direction in the sense of the present invention can comprise or include, in addition to a (movement) component in this advance direction, also a (movement) component transverse to the advance direction, which is preferably effected in a positive or mechanical manner by the first or second calibration element that contacts the calibration element fixed to the robot arm. Accordingly, in one embodiment, when the calibration element fixed to the robot arm is displaced relative to the first or second calibration element contacting it in an advance direction, the calibration element fixed to the robot arm can, in addition to this displacement, carry out a movement transverse to this advance direction relative to this calibration element contacting it, which movement is effected in a positive or mechanical manner by the contacting, i.e., first or second, calibration element. Thus, in one embodiment, during a (force-controlled) movement, in the first or second advance direction, of the calibration element fixed to the robot arm relative to the first or second calibration element contacting the robot arm-fixed calibration element, the force controlling effects, in particular mechanically and/or positively, a relative movement coupled to the displacement in this advance direction, transversely thereto, so that the calibration element fixed to the robot arm is guided into the corresponding end position using or exploiting a single degree of freedom, in particular the degree of freedom in the advance direction.

Further advantages and features arise from the dependent claims and from the exemplary embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1: depicts a system according to one embodiment in accordance with the present invention;

FIG. 2: depicts a plan view of a first calibration element of FIG. 1; and

FIG. 3: illustrates a method according to an exemplary embodiment in accordance with the present invention.

### DETAILED DESCRIPTION

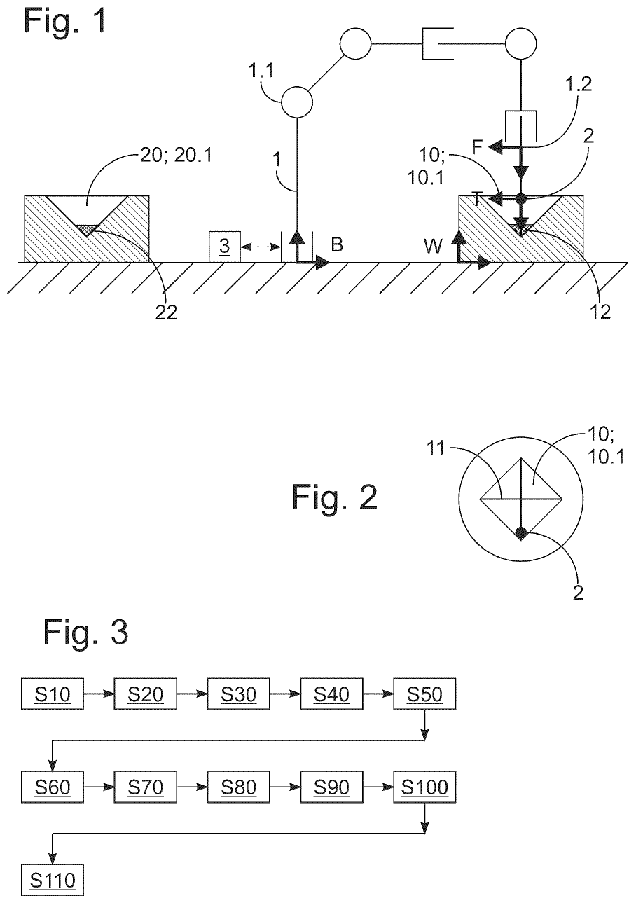

FIG. 1 shows a system according to an exemplary embodiment of the present disclosure, which comprises a robot arm 1 with a robot arm base, with respect to which a coordinate system B fixed to the robot arm base is defined, and an end flange 1.2, with respect to which a coordinate system F fixed to the end flange is defined, as well as a controller 3 for controlling the robot arm 1.

A calibration element fixed to the robot arm of a measuring device of the system with a partially spherical surface or contact surface 2 is arranged on the end flange 1.2.

The measuring device also comprises a first calibration element 10 with a guide surface 10.1, which is formed by a recess in the shape of a pyramid, the edges 11 of which (in the exemplary embodiment, four by way of example) form guides for guiding the spherical upper or contact surface of the calibration element 2 fixed to the robot arm along one-dimensional, straight guide paths. The tip region of the pyramid-shaped recess, in which the spherical upper or contact surface of the calibration element 2 fixed to the robot arm is finally stopped in a positive-fitting manner in a clearly defined first position when inserted into the recess, is indicated in FIG. 1 by cross-hatching for illustration purposes and forms a cavity 12, wherein the guide surface 10.1 converges in a funnel-like manner towards this cavity 12.

The measuring device further comprises a second calibration element 20 with a guide surface 20.1, which is formed by a recess in the form of a cone, the tip region of which analogously stops the spherical upper or contact surface of the calibration element 2 fixed to the robot arm in a form-fitting manner in a clearly (defined) second position when inserted into this recess.

To calibrate the robot arm 1, the controller 3 first controls it into a position in which the spherical upper or contact surface of the calibration element 2 fixed to the robot arm is roughly at least partially positioned within the recess of the first calibration element 10 (FIG. 3: step S10).

Then the controller 3 moves the calibration element 2 fixed to the robot arm relative to the first calibration element 10 in a first advance direction, which is vertically downward in FIG. 1, with the aid of the robot arm 1 by moving the robot arm 1 accordingly in a force-controlled manner (FIG. 3: step S20).

During this movement, the calibration element 2 fixed to the robot arm meets the guide surface 10.1. Then, with further force-controlled insertion into the recess with the aid of the robot arm 1, it is first inserted as far as one of the edges 11 and then along this edge into the cavity 12, while being guided mechanically or positively by the guide surface 10.1 or edge 11.

When the calibration element fixed to the robot arm is stopped in the cavity 12 and is at a first end position X₁, in this first calibration setting of the robot arm 1 the settings q₁₁ of its joints are detected, one of which is designated 1.1 in FIG. 1 as an example (FIG. 3: step S30), wherein the calibration element fixed to the robot arm continues during this detection to exert a force-controlled contact force on the guide surface 10.1 in the cavity 12.

Before this, the settings q₁₀ of the joints are detected at least once during the travel along the edge 11 in a further calibration position of the robot arm 1 that is traveled through.

While the calibration element fixed to the robot arm continues to exert a force-controlled contact force on the guide surface 10.1 in the cavity 12, the robot arm 1 is adjusted from the first calibration setting into at least one further calibration setting, wherein the calibration element fixed to the robot arm continues to be arranged in the first end position or maintains the first end position due to the force-controlled contact force in interaction with the cavity 12 (FIG. 3: step S40). Also in this further calibration setting, the settings q₁₂ of the joints are detected (FIG. 3: step S50), wherein during this detection the calibration element fixed to the robot arm continues to exert a contact force on the guide surface 10.1 in the cavity 12 in a force-controlled manner.

In one embodiment, the orientation of the calibration element fixed to the robot arm can be changed relative to the first calibration element 10 when adjusting to the further calibration setting. Thereafter, in one embodiment, while maintaining the first end position and the orientation of the calibration element fixed to the robot arm relative to the first calibration element, the robot arm 1 can be adjusted to at least one further calibration setting and the settings of the joints can also be detected in this or these additional calibration setting(s). Likewise, when adjusting the robot arm 1 from the first calibration setting to a further calibration setting, the calibration element fixed to the robot arm can maintain both the first end position and its orientation relative to the first calibration element and, if necessary, the robot arm can then be adjusted to at least one further calibration setting while maintaining the first end position of the calibration element fixed to the robot arm and changing its orientation relative to the first calibration element.

Subsequently, in an analogous manner, with the aid of the robot arm 1 the spherical upper or contact surface of the calibration element 2 fixed to the robot arm is roughly positioned at least partially within the recess of the second calibration element 20 (FIG. 3: step S60).

Then the controller 3 moves the calibration element fixed to the robot arm relative to the second calibration element in a second advance direction, which is also vertically downward in FIG. 1, with the aid of the robot arm 1, by moving the robot arm 1 accordingly in a force-controlled manner (FIG. 3: step S70).

During this movement, the calibration element fixed to the robot arm meets the guide surface 20.1. It is then, with further force-controlled movement, moved into the recess with the aid of the robot arm 1 up to the tip region of the conical recess, while being mechanically or positively guided by the guide surface 20.1.

When the calibration element fixed to the robot arm is stopped in the second cavity 22 formed by this tip region and is in a second end position X₂, in this second calibration setting of the robot arm 1 the positions q₂₁ of its joints are detected (FIG. 3: step S80), wherein during this detection the calibration element 2 fixed to the robot arm continues to exert a force-controlled contact force on the guide surface 20.1 in the cavity 22.

While the calibration element 2 fixed to the robot arm continues to exert a force-controlled contact force on the guide surface 20.1 in the cavity 22, the robot arm 1 is adjusted from the second calibration setting into at least one further calibration setting, wherein the calibration element fixed to the robot arm continues to be arranged in the second end position or maintains the second end position due to the force-controlled contact force in interaction with the cavity 22 (FIG. 3: step S90). Also in this further calibration setting, the settings q₂₂ of the joints are detected (FIG. 3: step S100), wherein during this detection the calibration element fixed to the robot arm continues to exert a contact force on the guide surface 20.1 in the cavity 22 in a force-controlled manner. As explained above with reference to the first calibration element, in two or more of the calibration settings the calibration element fixed to the robot arm can comprise the same end position and different orientations and/or the same end position and orientation.

The end positions are known in a coordinate system W fixed to the surroundings, for example are specified based on measurements. Then, in a step S110, a kinematic model of the robot arm 1 can be calibrated by determining, purely as an example, parameters p of the model V such that the sum of the deviation |X₁−V (q₁₂, p)|+|X₁−V (q₂₂, p)|+|X₂−V (q₂₁, p)|+|X₂−V (q₂₂, p)| becomes minimal.

Additionally or alternatively, in step S110 a transformation between the coordinate system W fixed to the surroundings and the coordinate system B fixed to the robot arm base, and/or between the coordinate system F fixed to the end flange and a coordinate system T fixed to the robot tool, can be determined in a manner known per se, for example on the basis of the relationship _{F}T_{T}·_{B}T_{F}(q)·_{W}T_{B}=_{W}T_{F}, where _{W}T_{B} designates the (sought) transformation from the coordinate system W fixed to the surroundings to the robot arm base-fixed coordinate system B (which determines the pose of the robot base relative to the surroundings or the coordinate system W fixed to the surroundings), _{B}T_{F} designates the transformation from the robot arm base-fixed coordinate system B to the end flange-fixed coordinate system F, which transformation depends on the joint settings q and is determined with the aid of the, or a, kinematic model, _{F}T_{T} designates the (sought) transformation from the end flange-fixed coordinate system F to the robot tool-fixed coordinate system T (which determines the pose of the robot tool relative to the end flange), and _{B}T_{T} designates the transformation from the coordinate system W fixed to the surroundings into the robot tool-fixed coordinate system arranged in the corresponding end position, which transformation can be determined on the basis of a measurement of the cavities 12, 22 relative to W. During this calibration, the various recorded joint settings and the corresponding known end positions are again used.

In addition, due to the two settings q₁₀, q₁₁ along the edge 11, whose orientation relative to W is known on the basis of a measurement of the guide surface 10.1, in addition to the position an orientation of the robot tool-fixed coordinate system arranged in the first end position is also known and can be used advantageously in the calibration described above.

Although exemplary embodiments have been explained in the preceding description, it is pointed out that a large number of modifications is possible.

Thus, purely by way of example, a first and a second calibration element have been explained, of which one, purely by way of example, comprises a guide surface in the form of a pyramid-shaped depression (the edges of which form guides for guiding the calibration element fixed to the robot arm into the cavity 12 along a one-dimensional, straight guide path) and the other, again purely by way of example, comprises a guide surface in the form of a conical depression. Of course, both calibration elements can comprise a pyramid-shaped or conical recess or a different type of recess. Additionally or alternatively, instead of a shape of a pyramid with four edges, a shape of another pyramid, for example with only three edges, can be used. Additionally or alternatively, one or more further second calibration elements can be provided or used in an analogous manner, as has been illustrated purely by way of example with reference to the second guide surface 20.1. Additionally or alternatively, one or more of the calibration elements can be oriented to the surroundings in a different way, for example can comprise horizontal or upward advance directions, which can in particular improve the flexibility and/or space requirement.

As already mentioned, a force-controlled movement can also include additional position controlling, in particular a hybrid force-position controlling. Purely by way of example, in the embodiment described above an advance movement in the corresponding advance direction can be carried out in a position-controlled manner in the advance direction and the robot arm 1 with the calibration element 2 fixed to the robot arm can deviate transversely thereto, i.e., horizontally in the embodiment, as a result of the guidance by the corresponding calibration element fixed to the surroundings, in a force-controlled manner.

It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot arm
1.1 Joint
1.2 End flange
2 Calibration element fixed to the robot arm
3 Robot arm controller
10 First calibration element
10.1 Guide surface
11 Edge
12 Cavity
20 Second calibration element
20.1 Guide surface
22 Cavity
B Coordinate system fixed to the robot arm base
F Coordinate system fixed to the end flange
T Coordinate system fixed to the robot tool
W Coordinate system fixed to the surroundings

What is claimed is:

1. A method for calibrating a robot arm (1), comprising multiple joints (1.1), with the aid of a measuring device that comprises a first calibration element (10) and a calibration element (2) which is fixed to the robot arm and which can be moved relative to the first calibration element by adjusting joints of the robot arm, wherein the first calibration element and the calibration element fixed to the robot arm are designed such that in the event of a displacement of the calibration element fixed to the robot arm relative to the first calibration element in an advance direction, the calibration element fixed to the robot arm is guided by the first calibration element from various starting positions to the same defined end position, said method comprising the following steps:
positioning (S10) the calibration element fixed to the robot arm relative to the first calibration element in one of the starting positions with the aid of the robot arm;
moving (S20), in a force-controlled manner, the calibration element fixed to the robot arm relative to the first calibration element in the first advance direction with the aid of the robot arm, wherein during this movement the calibration element fixed to the robot arm is guided by the first calibration element to the first end position and, at this end position, the robot comprises a first calibration setting;
detecting (S30) first settings of the joints of the robot arm in the first calibration setting; and
calibrating (S110) the robot arm based on these first joint settings.

2-10. (canceled)

11. The method according to claim 1, characterized in that the measuring device comprises at least one second calibration element (20), wherein the second calibration element and the calibration element fixed to the robot arm are designed such that when the calibration element fixed to the robot arm is displaced relative to the second calibration element in a second advance direction, the calibration element fixed to the robot arm is guided from different second starting positions by the second calibration element to the same defined second end position; wherein the method comprises the steps:
positioning (S60) the calibration element fixed to the robot arm relative to the second calibration element in one of the second starting positions with the aid of the robot arm;
moving (S70), in a force-controlled manner, the calibration element fixed to the robot arm relative to the second calibration element in the second advance direction with the aid of the robot arm, wherein during this movement the calibration element fixed to the robot arm is guided by the second calibration element to the second end position and at this end position the robot comprises a second calibration setting; and
detecting (S80) second settings of the joints of the robot arm in the second calibration setting;
wherein the robot arm is calibrated based on the first and these second joint settings (S110).

12. The method according to claim 1, characterized by the steps of:
adjusting (S40) the robot arm from the first calibration setting into at least one further calibration setting in which the calibration element fixed to the robot arm is arranged in the first end position; and
detecting (S50) further settings of the joints of the robot arm in this further calibration setting;
wherein the robot arm is calibrated based on the first and these further joint settings (S110).

13. The method according to claim 12, characterized in that
when adjusting the robot arm from the first calibration setting to a further calibration setting in which the calibration element fixed to the robot arm is arranged in the first end position, when adjusting the robot arm between at least two calibration settings of the robot arm, the calibration element fixed to the robot arm is arranged in the first end position and an orientation of the calibration element fixed to the robot arm relative to the first calibration element is maintained, during the detection settings of the joints of the robot arm in these at least two calibration settings are detected, and the robot arm is calibrated on the basis of these detected settings of the joints; and/or
when adjusting the robot arm from the first calibration setting into a further calibration setting in which the calibration element fixed to the robot arm is arranged in the first end position, in at least two calibration settings of the robot arm the calibration element fixed to the robot arm is arranged in the first end position and the calibration element fixed to the robot arm comprises different orientations relative to the first calibration element in these at least two calibration settings, during the detection settings of the joints of the robot arm are detected in these at least two calibration settings, and the robot arm is calibrated on the basis of these detected settings of the joints.

14. The method according to claim 1, characterized in that the robot arm in the first calibration setting, in particular when adjusting from the first calibration setting to the further calibration setting, is force-controlled such that the calibration element fixed to the robot arm in the first end position exerts a contact force on the first calibration element and is supported by the first calibration element in the first end position.

15. The method according to claim 1, characterized in that one of the first calibration element and the calibration element fixed to the robot arm comprises a guide surface (10.1) with a cavity (12), wherein the other of the first calibration element and the calibration element fixed to the robot arm can be supported by the cavity in a defined support position which determines the first end position, wherein the guide surface converges towards the cavity.

16. The method according to claim 15, characterized in that the guide surface comprises at least one guide (11) for guiding the other of the first calibration element and the calibration element fixed to the robot arm into the cavity along a one-dimensional guide path.

17. The method according to claim 16, characterized by the step of:
force-controlled movement (S20) of the calibration element fixed to the robot arm relative to the first calibration element with the aid of the robot arm, wherein during this movement the calibration element fixed to the robot arm is guided by the guide along the guide path and settings of the joints of the robot arm are detected in at least two calibration settings (S20, S30);
wherein the robot arm is calibrated based on these joint settings (S110).

18. A system for calibrating a robot arm (1) that comprises multiple joints (1.1), wherein the system is set up to carry out a method according to claim 1 and/or comprises:
a measuring device which comprises a first calibration element (10) and a calibration element (2) which can be arranged on the robot arm, wherein the first calibration element and the calibration element which can be arranged on the robot arm are designed in such a way that, when the calibration element which can be arranged on the robot arm is arranged on the robot arm, this calibration element fixed to the robot arm can be moved relative to the first calibration element by adjusting the joints of the robot arm, and when the calibration element fixed to the robot arm is displaced relative to the first calibration element in a first advance direction, the calibration element fixed to the robot arm is guided from various first start positions to the same defined first end position by the first calibration element; and/or a controller (3) for controlling the robot arm to position the calibration element fixed to the robot arm relative to the first calibration element in one of the first starting positions with the aid of the robot arm;
controlling the robot arm to move, in a force-controlled manner, the calibration element fixed to the robot arm relative to the first calibration element in the first advance direction with the aid of the robot arm, wherein during this movement the calibration element fixed to the robot arm is guided by the first calibration element to the first end position and at this end position the robot comprises a first calibration setting; and detecting first settings of the joints of the robot arm in the first calibration setting; and/or a calibration means for calibrating the robot arm based on these first joint settings.

19. A computer program or computer program product, wherein the computer program or computer program product includes instructions, in particular stored on a computer-readable and/or non-volatile storage medium, which, when executed by one or more computers, cause the computer(s) or system to carry out a method according to claim 1.
